(19) United States
(12) Patent Application Publication
(10) Pub. No.: US 2022/0200299 A1
(43) Pub. Date: Jun. 23, 2022

(54) Smart Power Hub for Power Tools

(71) Applicant: Robert Bosch GmbH, Stuttgart (DE)

(72) Inventors: Jeremy Rubens, Palatine, IL (US); Christopher Crowell, Chicago, IL (US)

(21) Appl. No.: 17/547,954

(22) Filed: Dec. 10, 2021

Related U.S. Application Data
(60) Provisional application No. 63/129,987, filed on Dec. 23, 2020.

(51) Int. Cl. H02J 7/00; B25F 5/02

(52) U.S. Cl. CPC H02J 7/0044; H02J 2207/10; B25F 5/029; H02J 7/0048

(57) ABSTRACT

A smart power hub having a number of electrical connections for power electric power tools. The smart power hub comprises a controller, a processor, and a number of sensors operable to measure operational behavior of the electrical connections or connected electric power tools. The processor may utilize data from the sensors to generate control commands for the controller to control the current output of the number of electrical connections. Additional functions of the processor may provide smart feature operation to connected tools.

### TECHNICAL FIELD

This disclosure relates to hubs providing electrical power and electric power tools.

### BACKGROUND

Electric power tools provide improve functionality of older manual tools to perform similar works. Increasingly, electric power tools are being developed with “smart” technology that can help user operate, maintain, and manage inventories of their electric tools. Such “smart” features would be desirable to retrofit onto older, conventional electric power tools to improve their functionality, adaptability, and lengthen their long-term utility.

### SUMMARY

One aspect of this disclosure is directed to a smart power hub configured to provide connectivity and smart functions to electric power tools, including retrofitting electric power tools that do not already have smart functions with sonic smart functionality. The smart power hub may comprise a housing having a power input, a controller at least partially disposed within the housing, a number of output circuits at least partially disposed within the housing, each output circuit having an output connection and being in electrical communication with the power input, and a processor in data communication with the controller. Each of the output circuits may further comprise a sensor in data communication with the processor. In some embodiments, each sensor may comprise a current sensor in electrical connection with the output connection. In some embodiments, each sensor may comprise an impedance sensor in electrical connection with the output connection. The processor may be operable to generate commands that the controller is configured to respond to in controlling the current flow to each of the output circuits. In some embodiments, the processor may be in wireless communication with the controller.

The above aspects of this disclosure and other aspects be explained in greater detail below with reference to the attached drawings.

### BRIEF DESCRIPTION OF THE DRAWINGS

FIG. 1 is a diagrammatic illustration of a smart power hub and an associated processor.

FIG. 2 is a diagrammatic illustration of an output circuit of the smart power hub depicted in FIG. 1.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

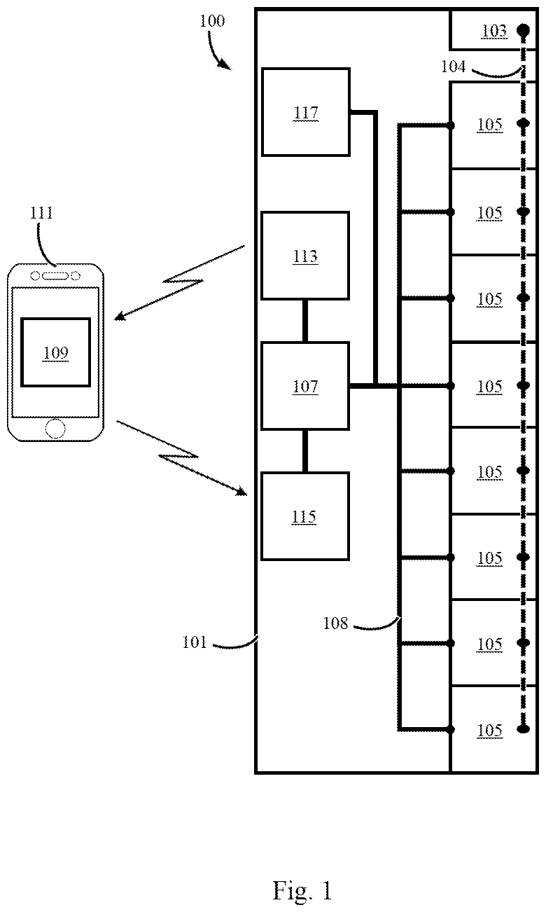

FIG. 1 is a diagrammatic illustration of a smart power hub 100 having a housing 101. Smart power hub 100 may comprise a master power input 103 at least partially disposed within housing 101. Master power input 103 may provide electric power to other components of smart power hub 100 via a power bus 104.

Master power input 103 may receive power from an external power source (not shown). In the depicted embodiment, the smart power hub 100 may be configured to accept a standardized alternating current (AC) power signal, but other embodiments may be configured to accept a direct current (DC) power signal without deviating from the teachings disclosed herein.

In the depicted embodiment, the master power input 103 may be rated to for an external power source comprising a standard AC wall outlet. By way of example, and not limitation, smart power hub 100 may be configured to accept to operate in North America utilizing 110-120V AC power at 60 Hz, but other embodiments may be configured to accept other power sources (such as other AC power standards found in other parts of the world) without deviating from the teachings disclosed herein. In some embodiments, master power input 103 may be configured to accept power from an external power source comprising a generator, a battery, or any other electrical power source known to one of ordinary skill in the art without deviating from the teachings disclosed herein.

Power bus 104 may provide power from the master power input 103 to a number of output circuits 105. In the depicted embodiment, each of output circuits 105 is in electrical communication with power bus 104 via a parallel wiring, but other embodiments may comprise other connection arrangements without deviating from the teachings disclosed herein. In some embodiments, each of output circuits 105 may be wired in series to power bus 104, or may comprise a combination of parallel and series wiring connections to power bus 104 without deviating from the teachings disclosed herein.

In the depicted embodiment, each of output circuits 105 is disposed at least partially within housing 101, and is configured to provide an electrical connection to an external electric power tool. Different ones of output circuits 105 may comprise different output specifications to accommodate different tools having different connector types, power requirements, voltage configurations, or safety standard without deviating from the teachings disclosed herein. In the depicted embodiment, smart power hub 100 comprises 8 output circuits 105, but other embodiments may comprise any arbitrary number of output circuits without deviating from the teachings disclosed herein. In embodiments having a plurality of output circuits 105, some of the output circuits may comprise different configurations or features than others of the output circuits 105 without deviating from the teachings disclosed herein.

Smart power hub 100 further comprises a controller 107 in data communication with each of the output circuits 105. In the depicted embodiment, controller 107 is in data communication. with each of output circuits 105 via a data bus 108. Data bus 108 may be operable to transmit and receive data between the elements of smart power hub 100 that are connected to data bus 108. Controller 107 may be further configured to be in data communication with a processor 109, and operable to transmit data to and receive commands from processor 109. In the depicted embodiment, controller 107 is disposed at least partially within housing 101 and processor 109 is disposed externally to smart power hub 100, but other embodiments may comprise other configurations without deviating from the teachings disclosed herein. In the depicted embodiment, processor 109 is associated with an external device 111. External device 111 may provide a user interface to control the functions of smart power hub 100, and may further utilize processor 109 to generate commands to configure controller 107. In the depicted embodiment, external device 111 comprises a smart phone, but other embodiments may comprise a different device, such as a mobile processing device, a tablet computer, a laptop computer, a wearable computing, device, a desktop computer, a personal digital assistant (PDA) device, a handheld processor device, a specialized processor device, a system of processors distributed across a network, a system of processors configured in wired or wireless communication, or any other alternative embodiment known to one of ordinary skill in the art without deviating from the teachings disclosed herein.

Utilizing data bus 108, controller 107 is operable to control the functions of each of output circuits 105. The functional control of output circuits 105 by controller 107 may be in response to commands received from processor 109. In the depicted embodiment, controller 107 is in wireless communication with processor 109 via a transmitter 113 and a receiver 115. In the depicted embodiment, each of transmitter 113 and receiver 115 are in data communication with controller 107 via a wired connection and also in data communication with processor 109 via a wireless connection. Other embodiments may comprise other arrangements having a single transceiver operable to both send and receive data between controller 107 and processor 109 in each direction without deviating from the teachings disclosed herein. Processor 109, transmitter 113, and receiver 115 may be configured to communicate wirelessly via one or more of an RF (radio frequency) specification, cellular phone channels (analog or digital), cellular data channels, a Bluetooth specification, a Wi-Fi specification, a satellite transceiver specification, infrared transmission, a Zigbee specification, Local Area Network (LAN), Wireless Local Area Network (WLAN), or any other alternative configuration, protocol, or standard known to one of ordinary skill in the art.

In some embodiments, processor 109 may be connected to controller 107 via a wired connection. In some such embodiments, the user interface provided by external device 111 may still be in data communication with processor 109 via a wireless data communication, or may utilize a wired connection. In some such embodiments, smart power hub 100 may comprise additional hardware controls disposed at least partially within or upon housing 101. Such controls may comprise knobs, buttons, dials, DIP switches, or other user interfaces recognized by one of ordinary skill to provide configurability to a controller without deviating from the teachings disclosed herein.

Although the depicted embodiment comprises a separate controller 107 and processor 109, other embodiments may utilize a single controller-processor embodiment, wherein a processor is disposed at least partially within housing 101 and has direct control over the functions of output circuits 103. In such embodiments, the controller-processor may comprise an interface also integrated into the housing 101, such as the controls mentioned above, or the interface may still be realized using an external device, such as external device 111. In some such embodiments, the smart power hub may comprise multiple forms of user interface, such as integrated controls of housing 101 and also a software interface provided by external device 111 without deviating from the teachings disclosed herein.

In the depicted embodiment, controller 107 may identify individual ones of output circuits 105 using an identifier data assigned to each circuit. These identifiers may be stored in a memory 117. Memory 117 may additionally be operable to store other data from controller 107, processor 109, or any of output circuits 105. In some embodiments, controller 107 may distinguish. between output circuits 105 without requiring identifier data, and thus other embodiments may not comprise a memory 117 without deviating from the teachings disclosed herein. In such embodiments, controller 107 may be configured into one of a selectable number of hard-wired connections to each of the output circuits 105 without relying upon a memory 117 to achieve control of the output circuits without deviating from the teachings disclosed herein.

In the depicted embodiment, each of controller 107, transmitter 113, receiver 115, and memory 117 may be in electrical communication with an electrical power source such as the power bus 104 (not shown) without deviating from the teachings disclosed herein. In some embodiments, only elements may require additional electric power, and thus only those particular elements may be in electrical communication with an electrical power source without deviating from the teachings disclosed herein.

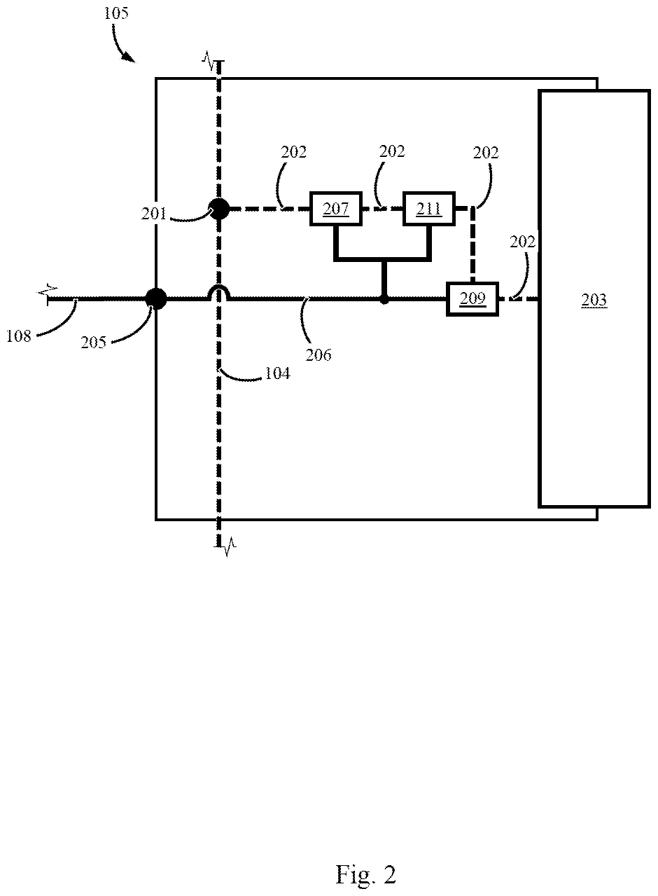

FIG. 2 provides a diagrammatic illustration of the components of an outlet circuit 105. In the depicted embodiment, power bus 104 runs through the circuit, but other embodiments may comprise other arrangements to provide power from power bus 104 without deviating from the teachings disclosed herein. In the depicted embodiment, electrical communication with power bus 104 and output circuit 105 is achieved via a power input 201 of the output circuit. Power input 201 provides electrical power to a power channel 202 that ultimately permits power to flow to an output connection 203. In the depicted embodiment, power input 201 may comprise a simple hard-wired connection between power bus 104 and power channel 202, but other embodiments may comprise additional features without deviating from the teachings disclosed herein. By way of example, and not limitation, a power circuit 105 may be configured to provide power to a particular electric power tool having a specified voltage and amperage that differs from the power signal provided by power bus 104. In such an embodiment, power input 201 may comprise circuitry designed to transform or modify the power signal, such as inductors, voltage step-ups, voltage step-downs, current limiters, shunts, transformers, diodes, rectifiers, or any other modification circuitry understood by one of ordinary skill in the art to modify an input signal into a power signal suitable for the particular electric power tool specified to be serviced by output circuit 105. In sonic embodiments, a modification circuitry associated with the output circuit 105 may itself be configurable, such as via controller 107 (see FIG. 1) without deviating from the teachings disclosed herein. Such embodiments may advantageously improve the versatility and adaptability of the output circuit 105, and in turn improve the versatility and adaptability of smart power hub 100 (see FIG. 1).

Output connection 203 may be configured to operate an associated electric power tool, or charge a battery. In the depicted embodiment, output connection 203 may comprise a grounded connector complying with a National Electrical Manufacturers Association (NTMA) standard, but other embodiments may comprise ungrounded NEMA connectors without deviating from the teachings disclosed herein. Other embodiments may comprise output connections having different configurations or conforming to different standards. By way of example, and not limitation output connections 203 may conform to a plug standard commonly found in the nation of intended use, such as a CEE 7 standard, ISO standard, or GB standard. In some embodiments of smart power huh 100 (see FIG. 1) having a plurality of output circuits 105, different ones of the output circuits may comprise an output connection 203 complying to different plug standards without deviating from the teachings disclosed herein. In some embodiments, one or more of output circuits 105 may comprise modular configurable output connections 203, which may be fitted with a modular connector by a user. In the depicted embodiment, output connections 203 are configured to provide AC power with a voltage and frequency matching that of power bus 104, but other embodiments may have other configurations providing different voltages or frequencies (such as DC) without deviating from the teachings disclosed herein. In some such embodiments, the specified power output of output connection 203 may be dictated by the configuration of power input 201 as described above. In some embodiments of smart power hub 100 having multiple output circuits 105, different ones of the output circuits may provide different power signals without deviating from the teachings disclosed herein.

Output circuit 105 may exchange data with controller 107 (see FIG. 1) via the data bus 108. Which is connected to the components of output circuits 105 by way of a data port 205 and a data channel 206. Output circuit 105 comprises a number of circuit elements that are in electrical communication with power channel 202 and data communication with data channel 206. The circuit elements may be utilized in conjunction with controller 107 and processor 109 (see FIG. 1) to implement certain “smart” functions of the output circuit that would be advantageous. In the depicted embodiment, the circuit elements comprise a current sensor 207 and an impedance sensor 209. Current sensor 207 is operable to measure the current draw of power channel 202 and output connection 103 and generate current data indicating the current measurement. Impedance sensor 209 is operable to measure the impedance load perceived by the output connection 103, including when an electric power tool is connected to output circuit 105. Impedance sensor 209 is additionally configured to generate impedance data indicating the impedance measurement. Each of the current sensor 207 and impedance sensor 209 are configured to transmit the current data and impedance data respectively (collectively referred to as “sensor data”) back to the controller 107 via data channel 206. The controller 107 may then transmit the sensor data to processor 109 for analysis or additional utilization.

Other circuit elements may be present without deviating from the teachings disclosed. herein. In the depicted embodiment, output circuit 105 further comprises a current governor 211 as a circuit element in electrical communication with power channel 202 and in data communication with controller 107 via data channel 206. Current governor 211 is operable to limit a maximum current draw of output connection 203, and may selectively perform such functions in response to data signals from controller 107. In the depicted embodiment, current governor 211 may further be operable to limit the rate of change of current draw, and in particular the rate of the increase in current draw by the output connection 203. Current governor 211 may be utilized by controller 107 to perform additional functions without deviating from the teachings disclosed below.

Output circuit 107 may additionally comprise other circuit elements not depicted in FIG. 2. By way of example, and not limitation, an additional circuit element may comprise a voltage governor, operable to control the voltage subjected to output connection 203. In some such embodiments, the voltage governor may be operable to increase or decrease the voltage expressed in the signal of power channel 202. By way of example, and not limitation, an additional circuit element may comprise an AC/DC switch, operable to present an alternating current or direct current to the associated output connection 203 if the other form of current is provided to power channel 202 respectively.

Processor 109 and controller 107 (see FIG. 1) may be configured to work in conjunction to provide a number of “smart” functions to the output circuits 105 utilizing the circuit elements of FIG. 2 and also other components of smart power hub 100 (see FIG. 1). Because such features are provided by the smart power hub 100, these features may advantageously be effectively retrofitted onto conventional “dumb” power tools.

A first such feature may comprise a “soft start” control for connected tools. Certain types of electric motors experience an increase in oscillation in response to an increase of current. Electric tools utilizing such motors may exhibit an unexpectedly-fast acceleration of the motor upon the initial onset activation of current draw. This so-called “onset acceleration” can make the tool more difficult to control and may result in misapplication of the tool by a user. For some types of tools, such as drills, hammer drills, saws, or angle grinders, having fine-control of the motor is advantageous to improve the safe operation of the tool. Current governor 211 may advantageously limit the rate of change in the current draw of a single connected tool. This limit in the rate of change creates a so-called “soft start” function for the tool, which is easier to anticipate and handle by the user in a safe and precise manner. In some embodiments, the maximum limit of the rate of change may be selectively determined by processor 109 or in response to user input In such embodiments, the maximum limit of rate of current change may be adjusted in response to a command generated by processor 109.

Another such feature may comprise a speed selection for connected tools. Because electric motors experience a change in oscillation speed that correlates with the current draw of a tool, a current governor 211 operable to provide a selectable maximum current draw can effectively retrofit a single-speed electric tool into a multi-speed electric tool. A user may input a desired speed to the processor 109, which in turn may generate a command for controller 107 to set a particular maximum current draw, thus providing a consistent maximum oscillation behavior. Such an implementation would be advantageous for users of tools that have very sensitive controls. Such tools may be very difficult to operate with finesse at lower speeds than the maximum oscillation speed of the motor,

Another such feature may comprise a total current limit utilizing the current governors 211 to prevent overdraw of current by any individual output circuit 105, but also prevent overdraw of current by the entire smart power hub 100 during operation. Multiple tools in use while simultaneously connected to smart power hub 100 will likely draw more current and require more power consumption than any single tool or smaller number of the tools) alone. However, a current draw that exceeds specified levels may result in blown fuses, or may trip circuit breakers. Processor 109 may monitor current sensor data received from all of the current sensors 207 of a smart power hub 100 concurrently to generate a total current draw. If the current draw approaches a pre-determined threshold value, processor 109 may generate commands instructing controller 107 to limit the current draw of some or all of the output circuits 105. In some embodiments, the command may cause controller 107 to lower the maximum current available to all of the output circuits in order to limit the maximum total current draw. In some embodiments, the command may cause controller 107 to selectively reduce the maximum current of particular ones of output circuits 205, such as an output circuit that is experiencing a substantially higher current draw than any other output circuit. Other embodiments may comprise other arrangements without deviating from the teachings disclosed herein. In some such embodiments, the current governor 211 may utilize a current foldback architecture, wherein a detected increase in current draw from one output circuit 105 results in a lowered maximum current draw for others of output circuits 105. In such an arrangement, smart power hub 100 may be resilient against overdraw even when experiencing a “current spike” caused by a sudden increase in current draw from one particular tool (e.g., by applying an unexpectedly-high mechanical load to the motor of the affected tool). Other embodiments may not utilize foldback techniques without deviating from the teachings disclosed herein.

Yet another feature of the output circuits 105 may comprise a conditional triggering of current draw, sometimes referred to as “side-chaining.” In such embodiments, a current governor 211 may restrict the current draw of its associated output circuit 105 unless another of the output circuits 105 experiences its own current draw above a threshold value. Such conditional triggering tiny be advantageously utilized for tools that are intended to be used in tandem by a single user. By way of example, and not limitation, an electric vacuum cleaner may be plugged into an output circuit that is configured to only pass current using a conditional trigger of another output circuit. Thus, a user may have an automatically triggered vacuum to clean up dust or debris when operating an electric saw or drill. Other arrangements may be implemented without deviating from the teachings disclosed herein.

Notably, because conditional triggering necessarily configures smart power hub 100 to provide current to multiple output circuits, the current governor of the conditional circuit may be configured to permit current draw only after a pre-determined window of time has passed after the master circuit has drawn sufficient current (e.g., 1 second after the master circuit has initiated operation of the tool). This delayed onset of current draw may advantageously prevent current spikes that may damage the tools, damage the smart power hub 100, or cause a fuse or breaker to trip.

In some embodiments, the master circuit may only trigger the conditional current draw if the master current draw is above a threshold value. In these such embodiments, a tool connected to the master may draw an amount of power less than is nominally required to operate its motor for other functions, such as trickle-charging a battery or providing power to the tools own smart functions, without deviating from the teachings disclosed herein. In some embodiments, the threshold value may be selectively changed by processor 109, such as in response to a user input indicating a new threshold, without deviating from the teachings disclosed herein.

Yet another smart feature that may be provided by smart power hub 100 may comprise Tool tagging. Tool tagging occurs when processor 109 utilizes sensor data, including impedance sensor data from impedance sensor 209, to identify the type of tool that is connected to a particular output connection 203. The impedance sensor data may be analyzed by processor 109 in order to develop an impedance profile that describes the tool.

In response to tool tagging, processor 109 may identify the type of tool connected to a particular output connection 203, and in response to the identification generate a message limiting the current draw of the associated output circuit 105 to a value that is known to be safe for the operation of the identified tool type.

In some embodiments, the impedance profile may be developed in view of the perceived load of the tool on the output connection 203 at various levels of current draw (i.e., when the tool is being used at various settings, including an inactive condition). This impedance profile may be compared to a corpus of known impedance profiles for various tools to identify the type of tool. The corpus of known impedance profiles may be stored in a memory accessible to processor 109, such as memory 117, or another memory without deviating from the teachings disclosed herein. In some embodiments, the processor 109 may continuously build and refine the impedance profile of a tool over time, and construct its own corpus of impedance profiles that reflect t to inventory of equipment that has been connected to smart power hub 100 over time.

In some embodiments, processor 109 may be operable to store identifiers for each tool in memory 117 in order to track the usage history and conditions of each tool. In some such embodiments, different tools of the same type may be given distinct identifiers (also called “tagging”), such that processor 109 is operable to track the distinct usage histories of each distinct tool within the inventory. In these embodiments, smart power hub 100 may be advantageously capable of generate a log of tool usage for each tool that has been connected with the hub, which may be utilized by users to track performance and plan maintenance or repair. These logs may advantageously be generated for tools that do not themselves have advanced or smart functions capable of generating similar logs. including conventional “dumb” electric power tools. In some embodiments, the tool logs may he stored in a memory accessible to processor 109, such as memory 117.

Another smart feature related to tool tagging may be the ability for processor 109 to generate messages to present to a user indicating useful information relating to the tool type and usage history. The usage history may be compared to known impedance profiles or behaviors of tools having common functional issues, and a message may be generated indicating a corresponding guidance in response. By way of example, and not limitation, messages may be generated that suggest a tool be cleaned or repaired, or that a tool's behavior as described by the sensor data has changed dramatically. In some embodiments having multiple tools of the same type, processor 109 may be operable to acknowledge a particular distinct tool in the total inventory in response to a user input identifying the tool. In some such embodiments, a particular user may be assigned a particular one of the tool, and thus identification of a particular tool may be correlated to an active user login or other supplied credential. Other embodiments may comprise other arrangements without deviating from the teachings disclosed herein.

Another smart feature related to tool tagging and tool logging may comprise a tool rating. Electrical power tools may each have an associated current rating at which the tool may be operated for long durations safely and without damaging the tool. However, electrical power tools may be operable to surpass the current rating in order to provide short-term performance when desired. In order to prevent damage to a tool from extended durations of operation above the rated current, processor 109 may generate a command to control a current governor 211 associated with the output circuit 105 to which the tool is connected after a predefined duration of time in which the rated current has been exceeded in operation. In some embodiments, the command may be overridden by a separate authorizing input from a user without deviating from the teachings disclosed herein.

In some such embodiments, the processor 109 ay instead generate a user message indicating the condition of exceeded current. In some such embodiments, the message may additionally provide guidance about nominal operating conditions, maintenance, or repairs to be considered in response to undesirable behavior experienced during tool operation. By way of example, and not limitation, processor 109 may generate a message indicating a higher than expected current draw for a tool during operation, and the message may suggest that the reason for this behavior may be that brushes within the electric motor require cleaning or replacement. These messages may be pre-generated and stored upon a memory accessible to the processor 109, such as memory 117. In such embodiments, processor 109 may selectively present a message to a user in response to receiving sensor data from the controller 107 that correlates with particular observable behaviors. In some embodiment, processor 109 may select a message in response to data within a stored tool log that correlates highly to known behaviors of the tool requiring attention.

User interaction with the smart functions described above may be realized utilizing a. user interface provided by either smart power hub 100, or by an interface device, such as external device 111. In the depicted embodiment of FIG. 1, the user interface may be provided as an app upon the smart phone configuration of external device 111, but other embodiments may provide an interface using other external devices. In some embodiments, a user interface may be at least partially disposed within or upon housing 101 without deviating from the teachings disclosed herein.

In the depicted embodiments, controller 107 may be configured to continuously maintain the commanded behaviors for the output circuits 105 until or unless an updated command is received from processor 109. Such an implementation advantageously permits the smart power hub 100 to function in a relatively autonomous manner from processor 109 once it has been configured in. a desired manner by the user. In the depicted embodiment, this continuous operation is applicable to each of the output circuits 105 individually, but multiple ones of the output circuits 105 may be controlled collectively, or all output circuits 105 may be treated collectively in some embodiments without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A smart power hub comprising:
a housing having a power input;
a controller at least partially disposed within the housing;
a number of output circuits each of the output circuits being at least partially disposed within the housing, in electrical communication with the power input, and comprising an output connection and a current sensor in data communication with the controller; and
a processor in data communication with the controller,
wherein each of the current sensors is configured to measure current draw of the output connection, wherein the controller is operable to control a current draw of each of the output connections in response to a control command received from the processor, and wherein the processor is operable to generate a control command in response to receiving a measurement from one of the number of output circuits that conforms to a predetermined condition.

2. The smart power hub of claim 1, further comprising:
a transmitter in data communication with the controller; and
a receiver in data communication with the controller, wherein the processor is disposed outside of the housing and the data communication between the controller and the processor comprises a wireless data communication utilizing the transmitter and the receiver.

3. The smart power hub of claim 2, wherein the processor comprises a smart phone processor.

4. The smart power hub of claim 1, wherein each of the output circuits further comprises a current governor that is configured to limit the maximum rate of current increase at the output connection.

5. The smart power hub of claim 1, further comprising a memory in data communication with the controller, wherein controller is configured to distinctly identify each of the number of output circuits using an identifier stored in the memory.

6. The smart power hub of claim 1, wherein the predetermined condition comprises a current spike at the output connection of one of the output circuits, and in response the processor is configured to generate a command that limits the maximum permissible current supplied to each of the other output circuits until the current spike measurements have dropped below a threshold level.

7. The smart power hub of claim 6, wherein the value of the maximum permissible current supplied to each of the other output circuits is dependent upon the total number of other output circuits actively drawing power.

8. The smart power hub of claim 1, wherein each of the output circuits further comprises an impedance detector in data communication with the controller, the impedance detector configured to measure the impedance of a device in electrical communication with the output connection.

9. The smart power hub of claim 8, wherein the processor is configured to identify a device connected to one of the output connection based upon the measured impedance of the device.

10. The smart power hub of claim 9, wherein the processor is operable to generate a command limiting a maximum current draw of an output circuit based upon the identified device connected to the associated output connection.

11. The smart power hub of claim 8, wherein the processor is operable to generate a behavior log of a device indicating the measurements of the current draw observed from the device while drawing current from the associated output circuit.

12. The smart power hub of claim 11, wherein the processor is operable to generate a user recommendation message in response to the behavior log, the user recommendation message indicating a suggested action for the user that correlates to the behavior log.

13. The smart power hub of claim 1, wherein the controller is configured to continuously function based upon the last received control command.

14. The smart power hub of claim 13, wherein the controller is configured to continuously function with respect to each of the number of output circuits independently, the continuous function of each of the number of output circuits being based upon the last received control command directed to that respective output circuit.

15. The smart power hub of claim 1, wherein the controller is operable to prevent a first current draw to a first of the number of output circuits unless a second current draw is measured at a second of the number of output circuits.

16. The smart power hub of claim 15, wherein the controller is operable to prevent the first current draw unless the second current draw is above a threshold value.

17. The smart power hub of claim 16, wherein the threshold value is a selectable threshold value and the controller is operable to adjust the selectable threshold value.
